(19) United States
(12) Patent Application Publication
(10) Pub. No.: US 2002/0095608 A1
(43) Pub. Date: Jul. 18, 2002

(54) Access control apparatus and method for electronic device

(76) Inventor: Richard S. Slevin, Los Altos Hills, CA (US)

Correspondence Address: Michael E. Woods, McCutchen, Doyle, Brown & Enersen, Three Embaracdero Center, Suite 2500, San Francisco, CA, 94111-4067, US

(21) Appl. No.: 09/761,112

(22) Filed: Jan. 16, 2001

Related U.S. Application Data
(60) Provisional application No. 60/246,230, filed on Nov. 6, 2000.

(51) Int. Cl. H04L 9/32

(52) U.S. Cl. 713/202; 340/5.52; 382/115; 902/3; 713/186

(57) ABSTRACT

A switch for power gating is disposed between an electronic device and its power source. The switch is controlled from a biometric reader that asserts a signal to the switch when a biometric profile matches a stored biometric signature. The gating of the power may thereby activate the electronic device. As the electronic device is isolated from its power source pending a successful biometric verification, it is not possible to circumvent the access control feature using the resources of the electronic device. Until the biometric reader verifies a biometric profile, the electronic device remains in an unpowered state.

### BACKGROUND

This invention relates generally to access control for electrically powered electronic devices, and more particularly to biometric access control of power gating provided to operating components of the electronic device.

Access control for electronic devices is known in the prior art. For example, access control includes physical control, in which the electronic device is protected from unauthorized access via physical access constraints. When the electronic device is a computing system, it is common to provide access control through applications or processes executing on the computing system. These applications or processes may, in some cases, be initiated by a boot sequence executed after power is applied to the computing system. An authorized user successfully interacts with the application or process to permit the electronic device to successfully boot or to otherwise direct the application or process to permit the user to access resources of the electronic device. Further, it is known to use biometric profiles to interact with the application or process to identify authorized users.

It is one disadvantage of these prior art solutions that the electronic device participates in the evaluation of a user's access status. Such participation is possible only when the electronic device is partially or wholly active. Many electronic devices have provision for redirecting boot-up control to an alternate instruction source. For example, if the electronic device is an IBM-compatible personal computer, boot-up control may be redirected by code contained on a floppy disk inserted in a floppy drive of the device, or by code contained on a CD-ROM, or special devices attached to various I/O (input/output) ports of the device. This alternate instruction source may include initiation instructions that disable, bypass, or otherwise defeat or thwart the access control protocol established for the electronic device.

Some prior art access control solutions tether a biometric sensor to a serial port of the electronic device. The electronic device must sufficiently activate itself to initiate the hardware port interface routines. In addition, it must activate and support any processes necessary to interact with the sensor and to make appropriate decisions regarding access.

It is one source of failure for the access control of such electronic devices when the alternate instruction source does not properly implement or initialize the access control features. In such cases, the access control for the electronic device may be defeated.

### SUMMARY OF THE INVENTION

The present invention is a simple, cost-effective electronic device access control solution. A preferred embodiment provides a switch for power gating disposed between an electronic device and its power source. The switch is controlled from a biometric reader that asserts a signal to the switch when a biometric profile of a prospective user matches a stored biometric signature. The gating of the power may thereby activate the electronic device. As the electronic device is isolated from its power source pending a successful biometric verification, it is not possible to circumvent the access control feature using the resources of the electronic device. Until the biometric reader verifies a biometric profile, the electronic device remains in an unpowered state.

A preferred embodiment of the invention is an access control system. The access control system includes an electronic device adapted for operation using power from a power source, the power source energizing a circuit of the electronic device for enabling a startup procedure of the electronic device; a switch, coupled between the power source and the processor, for enabling the energizing of said circuit responsive to an assertion of an activation signal; and a biometric reader coupled to the switch. The biometric reader including a memory for storing a biometric signature; a biometric sensor, coupled to the memory, for discerning a biometric profile; and a verifier, coupled to the biometric sensor and to the memory, for asserting the activation signal when the biometric profile matches the biometric signature.

An alternate preferred embodiment of the invention is a method for controlling access to an electronic device. The method includes discerning a biometric profile of a prospective user of the electronic device; comparing the biometric profile to a stored biometric signature of an authorized user of the electronic device; and thereafter asserting an activation signal to a switch when the prospective user is an authorized user, the switch interposed between a power source of the electronic device and a circuit of the electronic device for enabling a startup procedure of the electronic device such that the switch interrupts power to the circuit when the activation signal is not asserted.

It is another preferred embodiment of the present invention to provide for a process/device that uses a self contained embedded fingerprint identification system that is built into a electronic device, such as a laptop computer, PDA, PC, cell phone, or wireless or cordless telephone or other communication device. It protects the electronic device from being operated by anyone except the intended user. This preferred embodiment addressees the protection of laptop computers using fingerprint recognition, but it is understood that most any electronic device that requires power for its operation is a candidate for this solution and could use any biometric parameter or combination of parameters.

The access control is similar to the code protection on automobile radios whereby if the radio is stolen, and power is cut off to the radio (to remove it from the car), the radio will not work unless the proper code is input. Essentially, the embedded fingerprint “module” gates the power to the computer, preventing the computer from powering up without proper identification. By gating, it is meant that the device is placed between the power supply (either battery or corded to the wall plug). It will not allow power to flow to the device's initiation circuit (e.g., computer mother board) unless a correct identification is acknowledged by the biometric device (e.g., fingerprint device). Then, and only then will the fingerprint device switch the power on to the mother board allowing access to the PC.

This is different from a fingerprint device that would be attached to the computer (tethered) which operates under the computer's control. A tethered device runs off the computer's operating system with all the software and identification information accessible only through the computer system. The tethered device allows access to the computer, but disallows access to certain portions of the disk or files. If a computer is misappropriated, a tethered device offers no protection from theft, since the unauthorized user is able to circumvent the protection. When the existing data on the computer is not needed, the unauthorized user may simply reformat the boot drive, producing what is essentially a new computer. With the embedded fingerprint device, the unauthorized user cannot access the mother board and hence the operating system of the computer, and cannot turn it on without complete disassembly and damage to the computer.

There are alternate preferred embodiments to this invention. For example, as long as electronic devices require an initialization of the device using a BIOS or similar code, the biometric reader may be configured to provide an operation signal to the BIOS to inhibit operation at the BIOS level. Further, other physical parameter measuring devices may be used in lieu or in addition to the fingerprint module. For example, optical devices that scan a prospective user's retina, or audio devices that compare vocal signatures, or handwriting recognition systems for identification through dynamic handwriting parameters, or even other physical attributes.

Further, one or more biometric readers may be networked together or otherwise connected to a biometric signature server. It is possible that the access control could be used to provide differing levels of user access, depending upon access permissions associated with a biometric signature. This application could be further tailored to provide differing access based upon a particular electronic device. In some applications, the biometric reader could be used to automatically log a user on to the electronic device or to a network coupled to the electronic device.

Another alternate preferred embodiment provides an embedded system, inclusive of the processor, matching algorithms and stored identification information for the authorized users. The preferred embodiment would be an application for consumer and industrial safes. The advantage in this type of system is that the information regarding individual biometric signatures is stored along with the embedded module inside the safe, or in the case of most consumer products, behind substantial cover, thereby limiting access. Other fingerprint devices used in this application are stored on computers that are remote to the safe, which are intrinsically insecure because of their physical location.

Again, alternate physical parameters may be keyed and measured for use in conjunction with this preferred embodiment.

Other features and advantages of the present invention will be understood upon reading and understanding the detailed description of the preferred exemplary embodiments, found hereinbelow, in conjunction with reference to the drawings, in which like numerals represent like elements.

### BRIEF DESCRIPTION OF THE FIGURES

FIG. 1 is a schematic diagram of an access control system.

### DESCRIPTION OF THE SPECIFIC EMBODIMENTS

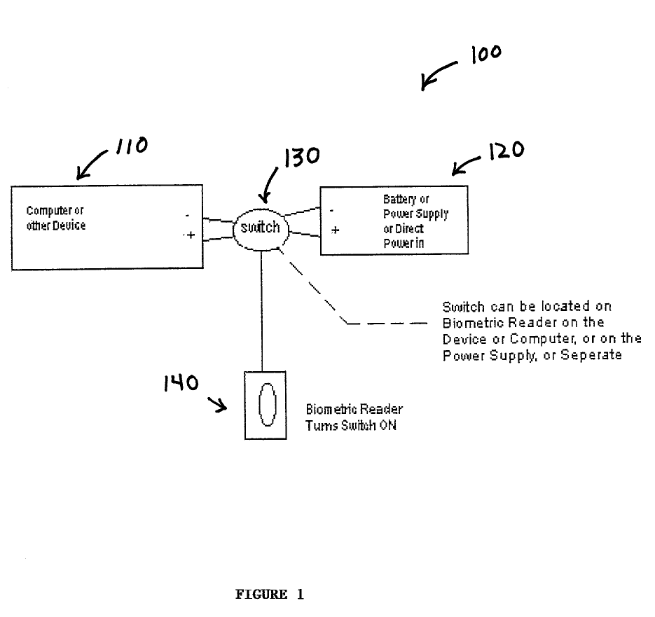

FIG. 1 is a schematic diagram of an access control system 100. Access control system 100 includes electronic device 110, a power source 120, a switch 130 and a biometric reader 140. Electronic device 110 may be a portable device, such as for example, a laptop computer or personal data assistant (PDA) or a personal computer or other device or apparatus to which a prospective user may desire access.

Electronic device 110 initiates and/or operates from power source 120 which provides electrical power. Power source 120 may be a battery, power supply or a direct power in connection. Switch 130 is interposed between electronic device 110 and power source 120. Switch 130 is responsive to an activation signal to gate power source 120 to provide initiation/operation power to electronic device 110.

Depending upon the specific application, switch 130 may be integrated into electronic device 110, power source 120, biometric reader 140, or provided as a discrete component.

Biometric reader 140 includes a memory, a biometric sensor and a biometric verifier for discern biometric parameters from a prospective user. The particular parameters discerned are dependent upon the type of biometric reader 140 that is used. In the preferred embodiment, biometric reader is adapted for use with fingerprints. Other biometric parameters, such as for example retinal patterns, vocal characteristics, dynamic handwriting indicia, or combinations of two or more parameters, may be used.

The memory of biometric reader 140 stores one or more appropriate biometric signatures of authorized users of electronic device 110. The biometric sensor discerns the appropriate biometric parameters and produces a biometric profile of the appropriate biometric parameters for a prospective user of electronic device 110. The verifier compares the biometric profile to the stored biometric signatures and asserts the activation signal to switch 130 upon a match.

Biometric reader 140 may be integrated into electronic device 110, power source 120, switch 130, or provided as a discrete component. Further, biometric reader 140 may be implemented in a client/server configuration in which the sensor is physically separate from the memory and verifier.

In operation, electronic device 110 is in the power-down or off state. A prospective user operates biometric reader 140, such as by, for example, pressing her finger against a sensor to establish a biometric profile including her fingerprint details.

Biometric reader 140 compares the biometric profile to the biometric signature stored in its memory. If the verifier determines that the profile matches the signature within a close enough margin, the verifier asserts the activation signal to switch 130.

Switch 130, in response to the activation signal, gates power source 120 to electronic device 110, thereby permitting electronic device 110 to operate or to be initiated in preparation for operation (e.g., boot sequence for a laptop computer).

A failure of the verifier to match the biometric profile to a stored biometric signature results in a non-assertion of the activation signal to switch 130, maintaining electronic device 110 in a power-down or off state.

Switch 130 is a state device in that it stores an operational state that is influenced by electronic device 110, power source 120 and biometric reader 140. Once biometric reader 140 successfully verifies a biometric profile and asserts the activation signal, the prospective user (now an authorized user) does not need to maintain her finger on the fingerprint sensor of biometric reader 140 (when using fingerprints). Further, when electronic device 110 is turned off after having been successfully activated, switch 130 is reset, requiring a subsequent successful verification of a biometric profile. Switch 130 is also reset when the biometric profile is incomplete or the verification has not been completed prior to removal of the prospective user's biometric input.

In an alternate preferred embodiment, switch 130 may selectively activate various BIOS routines, dependent upon information provided from biometric reader 140 regarding the authorized user's identity or classification, or other information associated with the user. Further, switch 130 may be used to log an authorized user into resources of electronic device 110, or coupled to electronic device 110 through a network.

From the foregoing description it is believed that the preferred embodiment achieves the objects of the present invention. Alternative embodiments and various modifications such as discussed herein and apparent to those skilled in the art, are considered to be within the spirit and scope of the present invention. The present invention is not limited by the foregoing description, but rather as defined as by the appended claims.

What is claimed is:

1. An access control system, comprising:
an electronic device adapted for operation using power from a power source, said power source energizing a circuit of said electronic device for enabling a startup procedure of said electronic device;
a switch, coupled between said power source and said processor, for enabling said energizing of said circuit responsive to an assertion of an activation signal; and
a biometric reader coupled to said switch, comprising:
a memory for storing a biometric signature;
a biometric sensor, coupled to said memory, for discerning a biometric profile; and
a verifier, coupled to said biometric sensor and to said memory, for asserting said activation signal when said biometric profile matches said biometric signature.

2. A method for controlling access to an electronic device, comprising:
discerning a biometric profile of a prospective user of the electronic device;
comparing said biometric profile to a stored biometric signature of an authorized user of the electronic device; thereafter
asserting an activation signal to a switch when said prospective user is an authorized user, said switch interposed between a power source of the electronic device and a circuit of the electronic device for enabling a startup procedure of said electronic device such that said switch interrupts power to said circuit when said activation signal is not asserted.
